(19) United States
(12) Patent Application Publication
(10) Pub. No.: US 2010/0231172 A1
(43) Pub. Date: Sep. 16, 2010

(54) High Efficiency Switching Linear Battery Charger with Low Power Dissipation

(75) Inventors: Siamak Bastami, Gilroy, CA (US); David Yen Wai Wong, San Jose, CA (US); Thomas Zoki Li, Mountain View, CA (US)

Correspondence Address: ADVANCED ANALOGIC TECHNOLOGIES, 3230 Scott Blvd, Santa Clara, CA, 95054, US

(73) Assignee: ADVANCED ANALOGIC TECHNOLOGIES, INC., Santa Clara, CA (US)

(21) Appl. No.: 12/403,655

(22) Filed: Mar. 13, 2009

(51) Int. Cl. H02J 7/00; G05F 1/00

(52) U.S. Cl. 320/137; 323/273

(57) ABSTRACT

A battery charger for a portable electronic device includes a linear charger to generate a substantially constant current for charging the battery and a switching voltage regulator to convert power supplied by an external adapter to a supply voltage for the linear charger. A feedback circuit controls operation of the switching voltage regulator so that the voltage supplied to the linear charger is substantially equal to the combination of the battery voltage and the drain-to-source voltage of the linear charger. In this way, power dissipation by the linear charger is minimized without requiring the use of a high accuracy current limited adapter.

In battery powered portable solutions, due to increased integration and features, the demand and requirement for higher current power sources is increasing. To accommodate this increased demand, larger and more efficient rechargeable batteries are being used. Among these, Lithium Ion (Li or Li Ion) based batteries are perhaps the most important type because of their high power density both in terms of volume and in terms of weight.

Efficiency, power dissipation, fast charge rate, and signal noise are some of the key concerns in charging batteries designed for portable applications. Two types of chargers are most commonly used: linear chargers and switching chargers. Of the two, linear chargers provide the least noise and can be configured to produce accurately regulated charging voltages. Switching chargers tends to produce more noise, but offer higher efficiencies and the ability to provide a boosted (increased) charging voltage.

As shown in FIG. 1, a typical charging sequence for a Lithium Ion based battery includes pre-charge, constant current and constant voltage phases. During the pre-charging phase, the battery is charged using a relatively low, fixed current (typically less that 1/10 of the battery's fast charge rate). This is followed by the regulated current phase where the charging current is fixed at a higher magnitude while the battery voltage continues to ramp. Once the battery voltage has reached its charged level, the constant voltage phase is initiated where current is regulated to maintain the battery's charged voltage.

In typical portable applications, an external adapter is used in series with an internal charger. If Vᵢₙ is the input voltage for the charger (and the output voltage of the adapter) the power dissipation requirement across the charger during each of these phases is equal to:

P_{diss}=(Vᵢₙ−V_{bat})*I_{chrg}

In the constant current phase, where the charge current (I_{chrg}) is constant, power dissipation is proportional to voltage difference between the input voltage and battery voltage (i.e., Vᵢₙ−V_{bat}). If it assumed that the input voltage is constant (i.e., linear charging), the power dissipation will be vary as function of increasing battery voltage (V_{bat}).

For example, if a typical adapter is used, an input voltage to the charger of 5.5V is common (i.e., Vᵢₙ=5.5V). If a LiIon battery is depleted to 3.0 volts and fully charged at 4.2 volts and a 1.5 Amp current is used for the constant current charging phase then the power dissipation will be 1.5 A*(5.5V−3.0V)=3.75 W at the beginning of charge and 1.5 A*(5.5V−4.2V)=1.95 W at the end of charge.

In general, this relatively high power dissipation presents certain challenges for designers of portable electronic devices. This is increasingly true because there is continuous pressure to reduce the size of internal charging systems which can severely limit their ability to dissipate heat generating during the charging process. One solution has been to use an external high accuracy current limited adapter in series with an internal charger to transfer the power dissipation from the charger to adapter. As shown in FIG. 2 shows, adapters of this type provide a relatively fixed output voltage over a wide range of output currents. Once the adapter current limit has been exceeded, however the output voltage decays rapidly. By operating the adapter at or near its current limit, the voltage at the input of the charger becomes:

Vᵢₙ=V_{bat}+V_{ds}_{_{—}}_{chrg}

where V_{ds}_{_{—}}_{chrg} is the voltage drop over the charger. So, if it is assumed that V_{ds}_{_{—}}_{chrg}=1V and the charge current is 1.5 Amp, the power dissipation will be 1.5 A*(4.0V−3.0V)=1.5 W at the beginning of charge (assuming, again that the battery is depleted to 3.0V). At the end of constant current charge phase, the power dissipation will be 1.5 A*(5.2V−4.2V)=1.5 W. Obviously, this is an improvement in power dissipation throughout the charging process.

In high volume applications, the cost of high accuracy current limited adapters is relatively high compare to standard adapters. And since most noise sensitive applications require linear chargers over switch mode charging, there is still a need for a relatively lower cost, low noise charging solution capable of supporting high charging currents (1.5 A to 2 A typical).

The objective of the recommended solution below is to provide a relatively lower cost system side solution which can provide a low noise, high current charging solution which can use a standard adapter and yet will have much lower power dissipation than the industry standard method.

### SUMMARY OF THE INVENTION

The present invention includes a battery charger for portable electronic devices. For a typical implementation, the battery charger includes a linear charger and a switching voltage regulator. The linear charger typically includes a transistor with its source connected to supply power to the battery being charged. The switching regulator is connected to an external power supply, typically a wall adapter or similar device. The output of the switching voltage regulator controls the voltage at the drain of transistor in the linear charger.

In use, the linear charger controls the gate of its transistor so that the battery is supplied with a constant charging current. As the battery is being charged, a feedback circuit controls the switching voltage regulator so that the voltage at the transistor drain is maintained at an optimal level. Typically, this means that this voltage is equal to (or slightly higher) than the sum of the battery voltage and the drain-to-source voltage of the transistor. In this way, the amount of power that is dissipated by the transistor is minimized without requiring the use of a high accuracy current limited adaptor.

### BRIEF DESCRIPTION OF THE DRAWINGS

FIG. 1 is a prior art graph showing the voltage of a lithium ion battery as a function of time as the battery is charged from a deleted state.

FIG. 2 is a graph showing output current as a function of voltage for a high-accuracy current limited adapted as provided by the prior art.

FIG. 3 is a block diagram of an implementation of the battery charger of the present invention.

FIG. 4 is a graph showing the voltage of a lithium ion battery and the voltage produced the switching portion of the battery charger of the present invention as a function of time as the battery is charged from a deleted state.

FIG. 5 is schematic of first implementation of the switching/linear battery charger of the present invention.

FIG. 6 is schematic of first implementation of the switching/linear battery charger of the present invention.

FIG. 7 is schematic of a feedback circuit as used by the implementations of FIGS. 5 and 6.

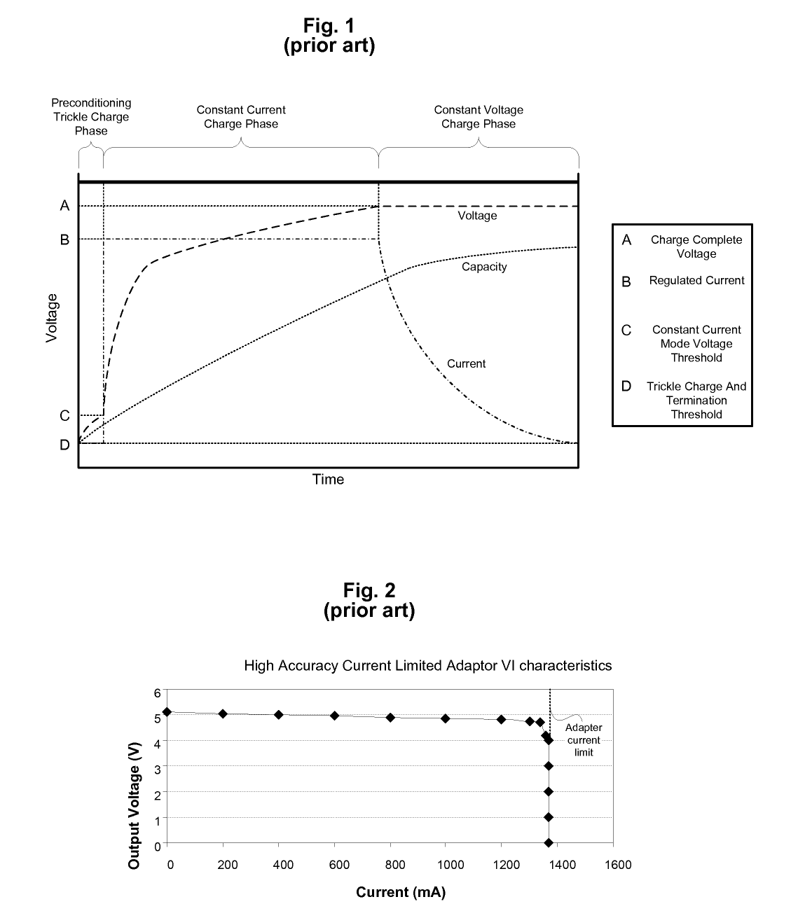

### DETAILED DESCRIPTION OF THE PREFERRED EMBODIMENTS

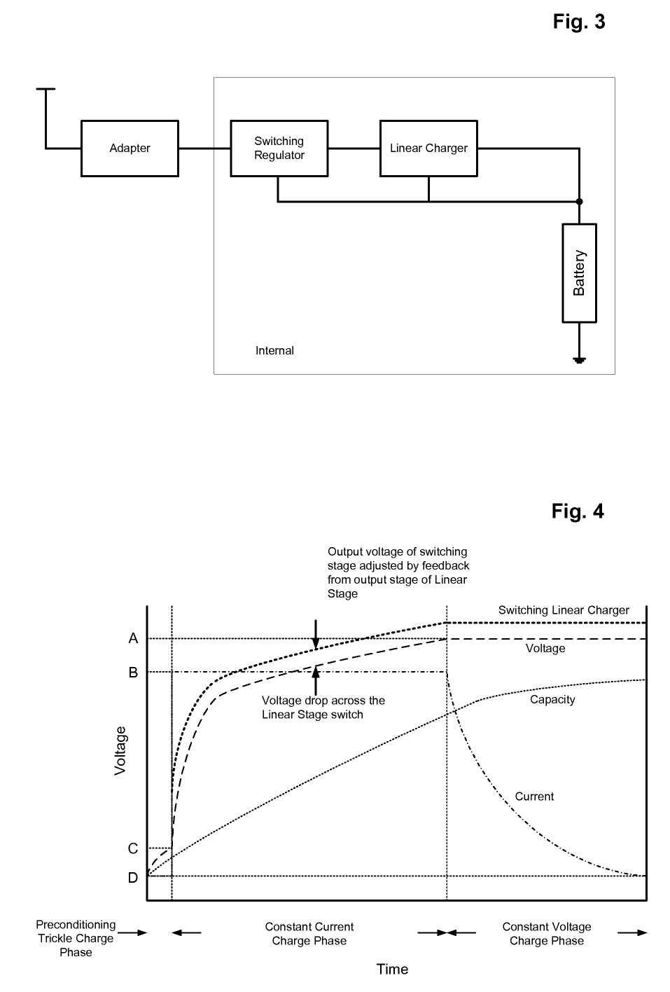

The present invention includes an apparatus and method for efficiently charging batteries in portable electronic devices. As shown in FIG. 3, a representative implementation of the battery charging apparatus includes a switching regulator connected in series with a linear charger. The output of the linear charger is connected to a battery. For typically applications, the switching regulator, linear charger and battery will all be included in a portable electronic device such as a cellular telephone or portable music player. An external adapter is used to provide an input voltage to the switching regulator.

The linear charger and switching regulator both receive a feedback voltage derived from the output voltage of the linear charger. As the battery is charged (and its voltage increases), the output voltage of the switching regulator is adjusted so that the input voltage to the linear charger is just enough to keep the keep the linear charger operating. This is shown, for example in FIG. 4. In this way, the power dissipation across the linear charger is reduced compared to traditional chargers without the expense of a high accuracy current limited adapter.

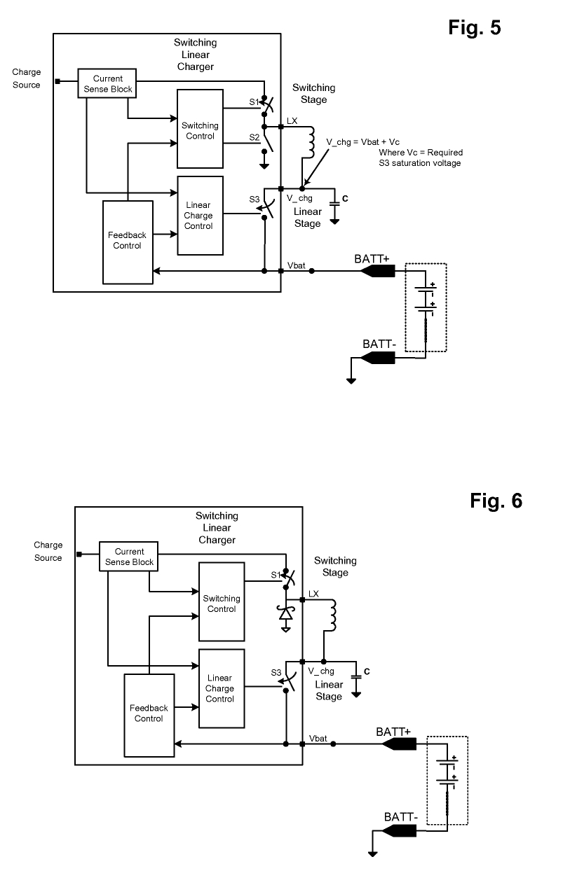

In FIG. 5, the first of two implementations for the charger of FIG. 3 is shown and generally designated 500. As in FIG. 5, a switching/linear charger 500 as provided by the present invention includes a switching control circuit that is connected to drive two switches (S1 and S2). The switches S1 and S2 are connected in a half-bridge configuration between an input pin and an internal ground node. In an actual system, the input pin would be connected to a power source (typically a wall adapter) and the internal ground node would be connected, via a ground pin to ground. An LX pin is connected to the middle of the half bridge between the switches S1 and S2.

Switching/linear charger 500 also includes a linear charge control circuit that is connected to drive a third switch S3. The switch S3 is connected between a V_{chg} pin and a V_{bat} bin of the switching/linear charger 500.

A feedback control circuit is connected to provide a feedback voltage representative of the voltage at the V_{bat} pin to the linear charge control circuit and the switching control circuit. A current sense circuit is connected to provide a current sense voltage representative of the current passing from the input pin and the switch S1 to the linear charge control circuit and the switching control circuit.

In use, the input pin is connected to a power source such as a wall adapter. An inductor and reservoir capacitor are connected in series between the LX pin and the V_{chg} pin. The V_{bat} pin is connected to the battery to be charged. The switching control circuit operates switches SI and S2 as a buck switching regulator. Switch S1 is turned ON (and switch S2 is turned OFF) during a charging phase. This causes current to flow from the input pin through the inductor to charge the reservoir capacitor and store energy in the inductor in the form of a magnetic field. The charging phase is followed by a discharge phase where switch S1 is turned OFF and the switch S2 is turned ON. During the discharge phase current flows from the inductor to the capacitor and ground. The charging phase and the discharging phase are repeated to maintain the voltage at the V_{chg} pin at a desired level.

Using the voltage at the V_{chg} pin as its input, the linear charge control circuit operates the switch S3 as a linear charger. This means that the linear charge control circuit modulates the drive to switch S3 to control the current and voltage supplied to the battery being charged. During constant current mode, the linear charge control circuit modulates the drive to switch S3 so that a constant current is delivered to the battery being charged. The magnitude of the constant current is typically preset to a value such as 1.5 A and is measured by the current sense circuit.

In FIG. 6, a second of two implementations for the charger of FIG. 3 is shown and generally designated 600. Switching/linear charger 600 is similar to the first implementation just described except that switching/linear charger 600 uses an asynchronous buck converter in place of the synchronous buck converter just described. Specifically, this means that the switching control circuit operates a single switch S1 and that the switch S2 is replaced with a diode. This simplifies the operation of the switching control circuit at the expense of somewhat lower efficiency (since there is a fixed voltage drop over the diode).

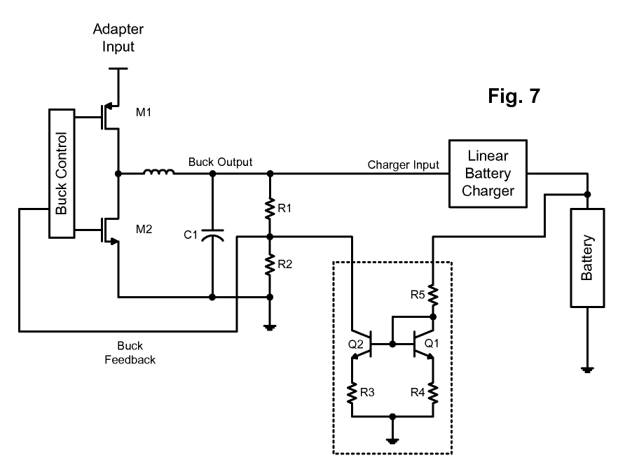

The key to efficient operation of switching regulators 500 and 600 is making the input voltage to the linear charger (i.e., the voltage at the V_chg pin) just enough to keep the keep the linear battery charger ON while the output voltage (battery voltage) is increasing. FIG. 7 shows an implementation 700 of a circuit that provides the necessary feedback for effective operation of the switching control circuit. As shown in FIG. 7, the feedback circuit includes resistors R1 and R2 coupled in series between the output voltage of the switching regulator (or the input voltage of the linear regulator) and ground. For the purposes of this description, it may be assumed that a node V1 exists between the two resistors.

The feedback circuit also includes a current mirror composed of transistors Q1 and Q2 along with resistors R3, R4 and R5. Resistor R5, transistor Q1 and resistor R4 are connected in series between the battery input voltage (i.e., the output of the linear charger) and ground. Transistor Q2 and resistor R3 are connected in series between the node V1 and ground. A bias current flows from the battery voltage through transistor Q1 to ground. The bias current is mirrored by transistor Q2 forcing the voltage at the node V1 to be proportional to the voltage at the battery input. Since the voltage at V1 functions as the feedback voltage for the buck regulator, the natural operation of the buck regulator maintains the voltage at its output at the level required to operate the linear charger as a function of battery voltage.

More concretely, assuming that R3=R4, R4+R5=R1, and Q1 and Q2 are identical sizes, then

V_{buck}=V_{bat}+[V_{ref}*(R1+R2)/R2−V_{be}]

where V_{be} is the base-emitter junction voltage of Q1.

So, it is further assumed that if the output of the switching regulator (V_{buck}) should be 300 mV higher than the battery voltage, the following component values may be used:

V_{ref}=600 mV

V_{be}=600 mV

R1=3 k ohms

R2=6 k ohms

R3=R4=300 ohms

R5=2.7 k ohms

V_{ref}*(R1+R2)/R2=1V

V_{buck}=V_{bat}+(1V−0.6V)=V_{bat}+300 mV

What is claimed is:

1. A method for charging a battery in a portable electronic device, the method comprising:
controlling a transistor within the portable electronic device so that the source of the transistor supplies the battery with a constant charging current; and
regulating, within the portable electronic device a voltage provided by an external supply to produce a voltage at the drain of the transistor that is substantially equal to the combination of the battery voltage and the drain-to-source voltage of the transistor.

2. A method as recited in claim 1 that further comprises generating a feedback voltage based on the battery voltage to regulate the voltage at the drain of the transistor.

3. A method as recited in claim 1 where the voltage at the drain of the transistor is chosen to minimize power dissipated by the transistor as it supplies the constant charging current.

4. A method for charging a battery in a portable electronic device, the method comprising:
controlling a linear charger within the portable electronic device to generate a current for charging the battery where the charging current remains substantially constant as the battery voltage increases; and
controlling a switching voltage regulator within the portable electronic device to convert power supplied by an external adapter to a supply voltage for the linear charger where the supply voltage is proportional to the battery voltage.

5. A method as recited in claim 4 that further comprises generating a feedback voltage based on the battery voltage to control the linear charger and the switching voltage regulator.

6. A method as recited in claim 4 where the supply voltage is chosen to be equal to or greater than the combination of the battery voltage and the voltage drop over the linear charger.

7. A battery charger for a portable electronic device that comprises:
a transistor having its source connected to a battery being charged;
a voltage regulator connected to control the voltage at the drain of the transistor; and
a feedback circuit configured to cause the voltage regulator to maintain the transistor drain voltage at a level substantially equal to the combination of the battery voltage and the drain-to-source voltage of the transistor while the transistor is supplying the battery with a constant charging current, where the transistor, voltage regulator and feedback circuit are included in the portable electronic device.

8. A battery charger for a portable electronic device that comprises:
a linear charger within the portable electronic device to generate a current for charging the battery where the charging current remains substantially constant as the battery voltage increases; and
a switching voltage regulator within the portable electronic device to convert power supplied by an external adapter to a supply voltage for the linear charger where the supply voltage is proportional to the battery voltage.
